(19) United States
(12) Patent Application Publication
(10) Pub. No.: US 2023/0420885 A1
(43) Pub. Date: Dec. 28, 2023

(54) TERMINAL FOR ELECTRICAL CABLES

(71) Applicant: Phoenix Contact GmbH & Co. KG, Blomberg (DE)

(72) Inventors: Gordon Busch, Blomberg (DE); Stephan Pollmann, Kalletal (DE)

(21) Appl. No.: 18/253,040

(22) PCT Filed: Nov. 9, 2021
(86) PCT No.: PCT/EP2021/081087

§ 371 Date: Jul. 17, 2023

(30) Foreign Application Priority Data
Nov. 17, 2020 (DE) 10 2020 130 345.9

(51) Int. Cl. H01R 13/639; H01R 4/48; H01R 11/09; H01R 13/502

(52) U.S. Cl. CPC H01R 13/639; H01R 4/48365; H01R 11/09; H01R 13/502; H01R 9/245

(57) ABSTRACT

The invention relates to a terminal (1) for electrical cables (L1, L2), comprising a housing (G) on which are provided at least two connections (A, A1-A6) for electrically connecting in each case one electrical cable (L1, L2) to one connection line (14, 14A-14F) arranged in the housing (G), wherein the connection lines (14, 14A-14F) are electrically disconnected from each other at a disconnection point (X1-X6) between two contacts (K, K1-K6). According to the invention, the housing (G) forms at least one receptacle (R) at which the contacts (K, K1-K6) of the disconnection point (X1-X6) of the connection lines (14, 14A-14F) are arranged such that they can be electrically contacted by a component (13, 18A-18C) which can be attached to the at least one receptacle (R).

### CROSS-REFERENCE TO PRIOR APPLICATIONS

This application is a U.S. National Phase application under 35 U.S.C. § 371 of International Application No. PCT/EP2021/081087, filed on Nov. 9, 2021, and claims benefit to German Patent Application No. DE 10 2020 130 345.9, filed on Nov. 17, 2020. The International Application was published in German on May 27, 2022 as WO/2022/106262 under PCT Article 21(2).

### FIELD

The invention relates to a terminal for electrical cables and to a system comprising at least one such terminal and at least two different components.

### BACKGROUND

A terminal of this type comprises a housing on which are provided at least two connections for electrically connecting in each case one electrical cable to one connection line arranged in the housing, wherein the connection lines are electrically disconnected from each other at a disconnection point between two contacts.

Such a terminal, in the form of a disconnection terminal with a plurality of parallel disconnection elements, is described in DE 20 2016 103 277 U1.

However, the known solution is limited in terms of flexibility of usability and variance of mounting options. In many cases, terminals of the known type can also only be used with specific mounting receptacles in dedicated systems. As a result, the production of the terminal usually has to be adapted in each case for each specific application, which may involve in particular the production of corresponding injection molds. This typically makes production time-consuming and cost-intensive and requires a corresponding lead time.

### SUMMARY

In an embodiment, the present invention provides a terminal for electrical cables, comprising: a housing on which are provided at least two connections for electrically connecting in each case one electrical cable to one connection line arranged in the housing, wherein the connection lines are electrically disconnected from each other at a disconnection point between two contacts, and wherein the housing forms at least one receptacle at which the contacts of the disconnection point of the connection lines are arranged such that they are electrically contactable by a component attachable to the at least one receptacle.

### BRIEF DESCRIPTION OF THE DRAWINGS

The present invention will be described in even greater detail below based on the exemplary figures. The invention is not limited to the exemplary embodiments. Other features and advantages of various embodiments of the present invention will become apparent by reading the following detailed description with reference to the attached drawings which illustrate the following:

FIG. 1 a view of an exemplary embodiment of a terminal for electrical cables in a state equipped with a plurality of disconnection elements, wherein the disconnection elements each are arranged in a contact position;

FIG. 2 a view of the terminal according to FIG. 1, wherein the disconnection elements are arranged in a disconnection position;

FIG. 3 a view of a first housing part, formed as a top shell, of a housing of the terminal according to FIG. 1;

FIG. 4 a view of a third housing part of the housing of the terminal according to FIG. 1;

FIG. 5 a view of a second housing part of the terminal according to FIG. 1, which housing part can be inserted between the first and third housing parts;

FIG. 6 a view of a plurality of connection lines, which form contacts that can be electrically contacted by means of the disconnection elements, and of the disconnection elements of the terminal according to FIG. 1;

FIG. 7 a cross-sectional view of the terminal according to FIG. 1;

FIG. 8 a cross-sectional view of the first housing part of the housing of the terminal according to FIG. 1;

FIG. 9 a circuit diagram of the terminal equipped according to FIG. 1, but with open contacts;

FIG. 10 a circuit diagram of the terminal according to FIG. 1, not equipped with components;

FIG. 11 a view of the components according to FIG. 6 inserted in the third housing part according to FIG. 4;

FIG. 12 a bus connection line of the terminal according to FIG. 1; and

FIG. 13 a view of the terminal according to FIG. 1, but as a set in a state partially equipped with other components.

### DETAILED DESCRIPTION

In an embodiment, the present invention provides an improved terminal for electrical cables.

Accordingly, it is provided that the housing forms at least one receptacle at which the contacts of the disconnection point of the connection lines are arranged such that they can be electrically contacted by a component which can be attached to the at least one receptacle.

This makes it possible to selectively attach one of several different components to the disconnection point in order to fulfill a certain one of several different functions depending on the requirements in the specific application. For example, the component is a disconnection element that is movable on the housing between a disconnection position and a contact position if mounted on the receptacle. Alternatively, the component can comprise, for example, a passive structural element, such as a resistor, or an active structural element, such as a relay. In this way, the terminal can be assembled as a disconnection terminal, for example, if required. Alternatively or additionally, the terminal can fulfill functions beyond this. This enables particularly flexible and versatile use of the terminal so that the same tools can be used to produce terminals with different functions.

At least one insertion slope is formed on the receptacle, for example. This facilitates the correct insertion of the component.

Optionally, at least one mounting region for the movable mounting of the component is formed on, in particular in, the receptacle. This enables not only rigid components to be attached to the receptacle but also movably mounted components to be attached to it, which can again significantly expand the possible range of applications for the terminal. The mounting region is arranged adjacent to an insertion slope, e.g., below it.

According to a development, the mounting region has a substantially circular cross-section. A component that can be moved on it can be mounted, e.g., pivotably, on the mounting region. Optionally, the mounting region is formed jointly by two housing parts that can be assembled together; that is, each of the two housing parts forms a section of the mounting region. It can be provided that both sections of the mounting region describe a circular arc in cross-section, in particular a semicircle or smaller in each case. In this way, the component can be mounted in a simple manner and directly on the two housing parts, and only a few parts are required. Together, the two sections of the mounting region form, for example, a circular cylindrical receptacle.

For example, the contacts are each formed on a slot, for example a slot in a piece of flat material made of electrically conductive material. This enables simple and at the same time reliable contacting, for example by a contact blade of a component.

The receptacle can be designed in the form of a shaft. In this way, the component can be at least partially inserted into the housing.

The terminal comprises (on the housing) a plurality of receptacles, for example arranged in a row. The terminal is designed, for example, in the form of a terminal strip. In this way, a plurality of variably selectable functions can be fulfilled with the one terminal.

One of the connection lines is designed in the form of a bus connection line, which has a plurality of contacts. Each of the plurality of contacts is arranged on one of the plurality of receptacles.

At least one of the connections is optionally designed in the form of a push-in connection. All connections of the terminal can also each be designed in the form of a push-in connection. This enables a particularly simple and rapid connection of the terminal. In addition, it is possible to design and arrange such push-in connections in a particularly space-saving manner.

According to one aspect, there is provided a system having at least one terminal according to any embodiment described herein and at least two different components, each attachable to the terminal. The at least two different components can each be selectively attached to the (same) at least one receptacle such that the (selected) component makes electrical contact with the contacts of the disconnection point of the connection lines.

Optionally, (at least) one of the components is designed in the form of a disconnection element with a contact blade for contacting the contacts of the at least two connection lines, wherein the disconnection element can be attached to (in particular in) the receptacle such that it is mounted so as to be movable between a contact position, in which the disconnection element electrically connects the contacts to each other, and a disconnection position, in which it electrically disconnects the two contacts from each other.

Furthermore, one of the components can comprise a passive or active electrical component, allowing for a variety of possible uses of the terminal.

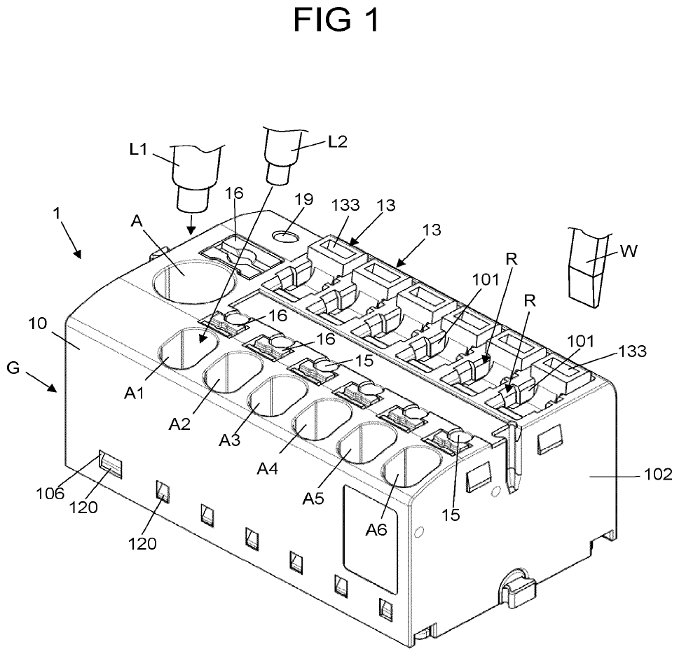

FIG. 1 shows a terminal 1 for connecting electrical cables L1, L2. The terminal 1 comprises a housing G comprising, in addition to a connection referred to herein for simplified reference as a bus connection A, a plurality of, exemplarily six (alternatively, for example, two, four, eight, ten or twelve) connections A1-A6, each for one electrical line L2. The bus connection A and each of the connections A1-A6 are provided on the common housing G. The bus connection A and each of the connections A1-A6 each form a receptacle into which an electrical line L1, L2 can be inserted in order to make electrical contact with a contact region inside the terminal 1. Via each of the connections A1-A6, a respective electrical line L2 connected thereto can be electrically connected to an electrical line L1 connected to the bus connection A.

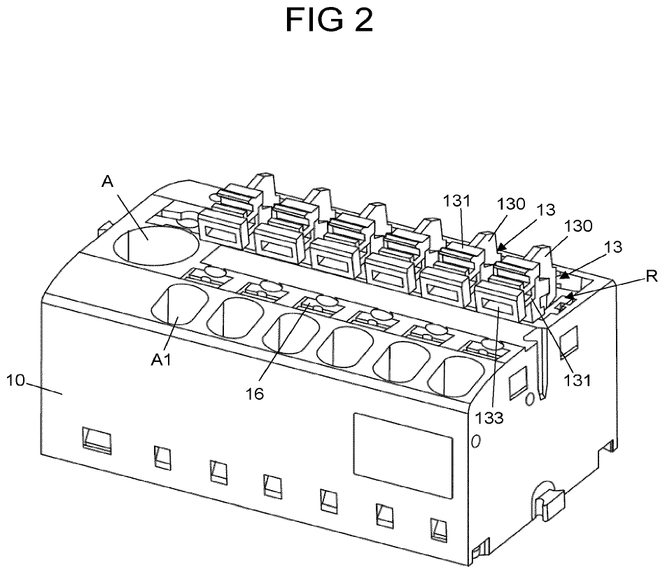

The housing G furthermore forms a plurality of receptacles R, six in the example shown. An external component can be inserted into each of the receptacles R, specifically such that the component can electrically contact contacts arranged within the respective receptacle. In the example shown in FIG. 1, a component in the form of a disconnection element 13 is mounted in each of the receptacles R. Thus, the terminal 1 according to FIG. 1 is configured in the form of a disconnection terminal. Each of the disconnection elements 13 is movably, in the example shown pivotably, mounted on the corresponding receptacle R of the terminal 1, specifically between a disconnection position and a contact position. FIG. 1 shows the disconnection elements 13 in each case in the contact position, in which the disconnection element 13 electrically connects the respective connection A1-A6 to the bus connection A. FIG. 2 shows the disconnection elements 13 in each case in the disconnection position, in which the respective connections A1-A6 are electrically disconnected from the bus connection A. By moving a disconnection element 13 into the disconnection position, an electric circuit can thus be opened. Conversely, an electric circuit can be closed by moving a disconnection element 13 into the contact position.

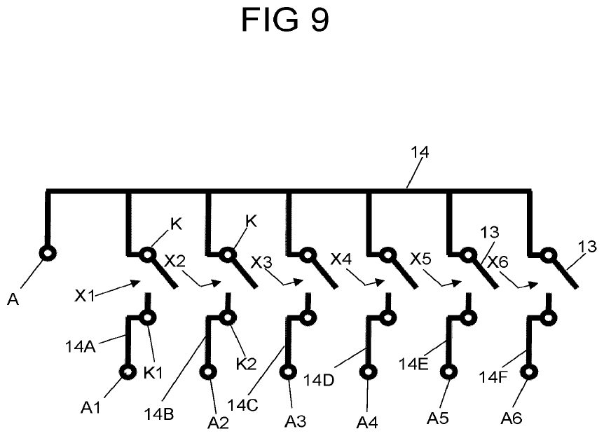

FIG. 9 shows this structure in the form of a circuit diagram. The bus connection A is electrically connected to a plurality of, in the present case six, contacts K via a connection line, which is referred to below as the bus connection line 14 for simplified reference. Each of the plurality of, in the present case six, connections A1-A6 is electrically connected to a contact K1-K6 via a respective connection line 14A-14E. The disconnection elements 13 are each mounted so as to be movable between the contact position, in which the respective disconnection element 13 electrically connects two contacts K, K1-K6 (namely, a contact of the bus connection line 14 and one of the contacts K1-K6 associated with the respective disconnection element 13), and the disconnection position, in which the disconnection element 13 electrically disconnects the two contacts K, K1-K6 from each other. In FIG. 9, the disconnection elements 13 are each shown simplified in the form of a switch; it should be noted that it is also possible for the disconnection elements 13 not to make electrical contact with either of the two contacts K, K1-K6, which can be electrically connected to them, in the respective disconnection position.

A disconnection point X1-X6 is thus provided between the bus connection line 14 and each of the connection lines 14A-14F, which disconnection point can be electrically closed by means of the respective disconnection element 13.

In order to move the disconnection elements 13 between the disconnection position and the contact position, each disconnection element 13 comprises an engagement region 133 for engagement by a tool W. In the present case, the engagement region 133 is designed in each case in the form of a slot, which can be engaged with the tool W designed as a slotted screwdriver.

The disconnection elements 13 are movably mounted on the housing G, specifically such that each of the disconnection elements 13 can be displaced in the respective receptacle R in the housing G. The receptacles R are each designed in the form of a shaft.

Based on FIGS. 1 and 2, it can also be seen that each of the disconnection elements 13 has a pivot body 131, on which the engagement region 133 is formed and to which a contact blade 130 is fastened. The contact blade 130 is made of electrically conductive material. The disconnection elements 13 may also be referred to as disconnection blades.

However, instead of some or all of the disconnection elements 13, other components may also be connected to the terminal 1.

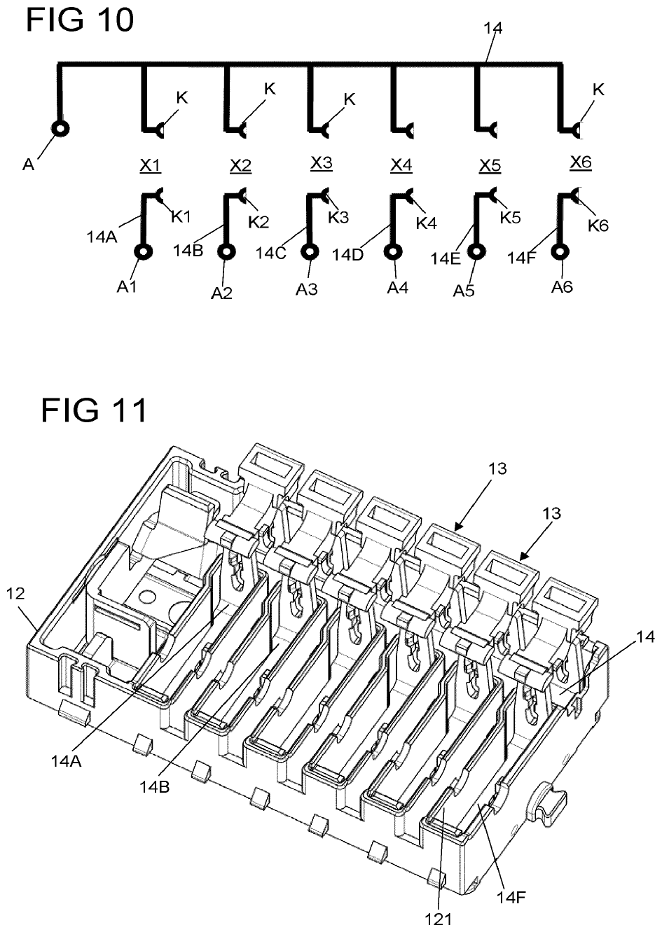

FIG. 10 shows a circuit diagram of the terminal 1 without disconnection elements 13 connected thereto. The respective pairs of contacts K, K1-K6 are spaced apart and electrically disconnected from each other (and thus isolated) at the corresponding disconnection point X1-X6.

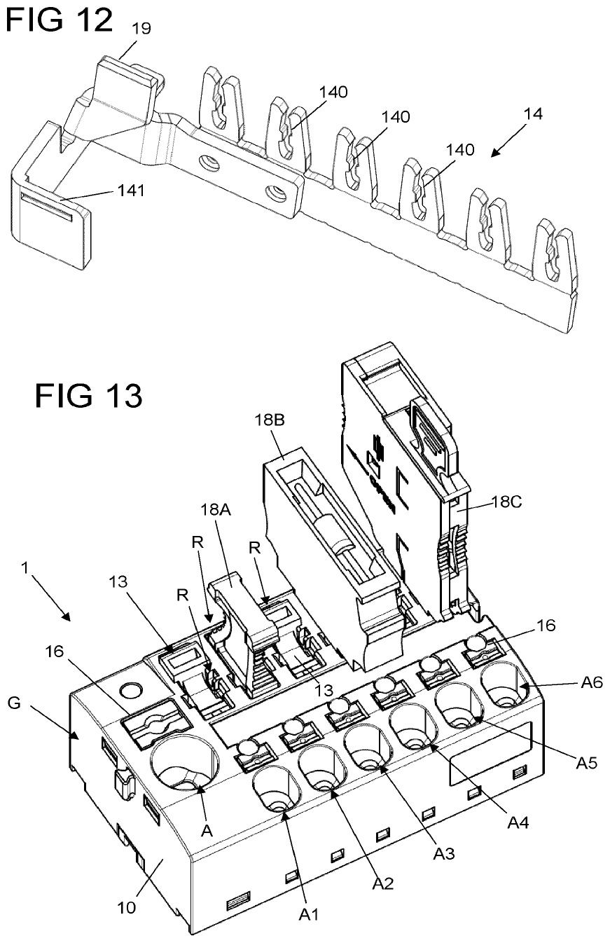

For comparison, FIG. 13 shows a system with the terminal 1, but in contrast to FIG. 1, other components 18A-18C are used instead of the disconnection elements 13 at some of the receptacles R. Specifically, a component 18A is provided in the form of a manually insertable and withdrawable bridge, to which the corresponding contacts K, K2 can be electrically connected. Furthermore provided is a component 18B that carries an electrical structural element and electrically connects it to the contacts K, K4 in the corresponding receptacle R. In the example shown, the structural element is a passive structural element, namely, for example, a diode, a capacitor or a resistor. Still another component 18C, which can fulfill further functionalities, is provided. Components with a fuse, with test devices, display devices and/or with measuring devices, for example, are conceivable.

Depending on the requirements, the terminal 1 can therefore be equipped accordingly. A system (or set) with the terminal 1 and a plurality of components 13, 18A-18C thus enables particularly flexible use.

The components 13, 18A-18C can (optionally) be removed from terminal 1 again without causing destruction. The terminal 1 can be re-equipped at the receptacles R by removing at least one component 13, 18A-18C mounted on a receptacle R. Thus, the function of the terminal 1 can be changed.

The bus connection A has a larger cross-section compared to the individual connections A1-A6. Both the bus connection A and the connections A1-A6 are designed in the form of push-in connections. The electrical cables L1, L2, for example wires, can thus be easily inserted into the respective receptacle A, A1-A6, in order to make electrical contact inside the terminal 1 and at the same time be held thereon. Such mode of operation is explained in more detail below. In order to release the connection of the electrical cables L1, L2 to the terminal 1, the terminal comprises a slider 16 in each case, which can be actuated by means of a tool, for example the tool W; in the present case, it can be pushed deeper into the housing G.

A test contact 15 is arranged next to each of the sliders 16 of the parallel connections A1-A6 at a housing opening. The potential applied to the respective connection line 14A-14F can be measured at the test contacts 15. Next to the bus connection A (more precisely: next to the slider 16 of the bus connection A), an opening is formed through which a test contact 19 can be accessed, for example in order to test a voltage applied to the bus connection A.

The housing G comprises a first housing part 10 shown in FIGS. 1 and 2, which in the present case is designed in the form of a top shell. The first housing part 10 is formed in one piece. The first housing part 10 can be produced and is produced in the present case by injection molding.

The housing G comprises positive-locking means, in the present case for forming dovetail joints, in order to be connected in a positive-locking manner to the terminals 1 of identical design or, generally, to suitably designed components. In this way, a plurality of terminals 1 and/or other components can be connected to form a longer row.

Insertion openings of the connections A, A1-A6 are arranged on the upper side of the first housing part 10. Likewise, the disconnection elements 13 are arranged on such upper side (and, in the example shown, so are the sliders 16). Furthermore, a labeling surface is (optionally) provided on the upper side, in the present case between the connections A1-A6 and the associated disconnection elements 13. The first housing part 10 forms a respective receiving section 101 of each of the receptacles R.

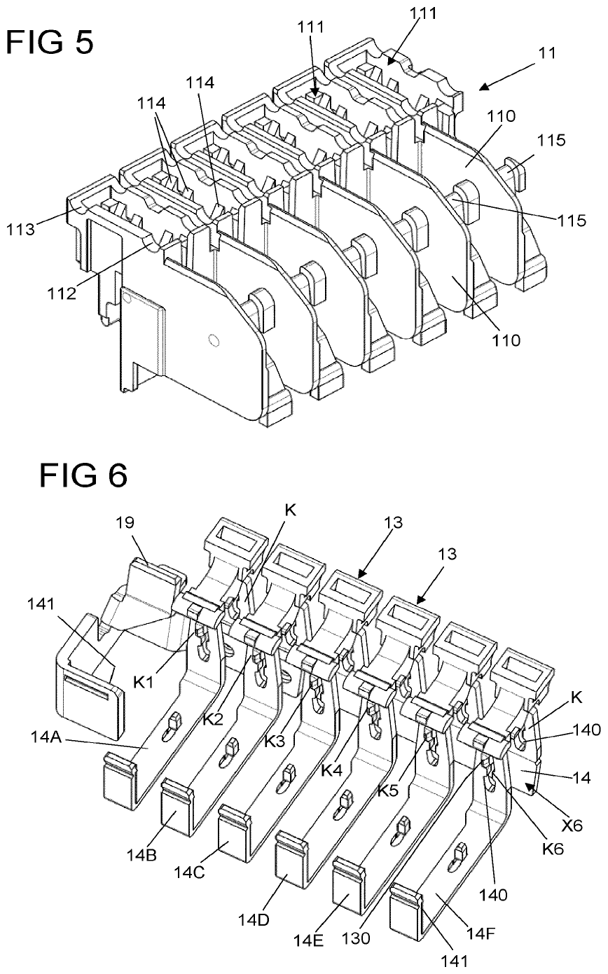

In addition to the (upper) first housing part 10, the housing G comprises a second housing part 11 (shown, for example, in FIG. 5) and a third housing part 12 (shown, for example, in FIG. 4).

In the mounted state of the terminal 1, the first housing part 10 is firmly connected to the third housing part 12, specifically in a positive-locking manner. For this purpose, the first and third housing parts 10, 12 comprise latching elements so that the housing parts 10, 12 can be fastened to each other easily, rapidly and reliably. In the present case, a plurality of openings 106 are provided on the first housing part 10, specifically in side walls (extending substantially perpendicularly to the upper side). Corresponding latching hooks 120 are formed on the third housing part 12, which latching hooks are configured to latch with the openings 106 of the first housing part 10.

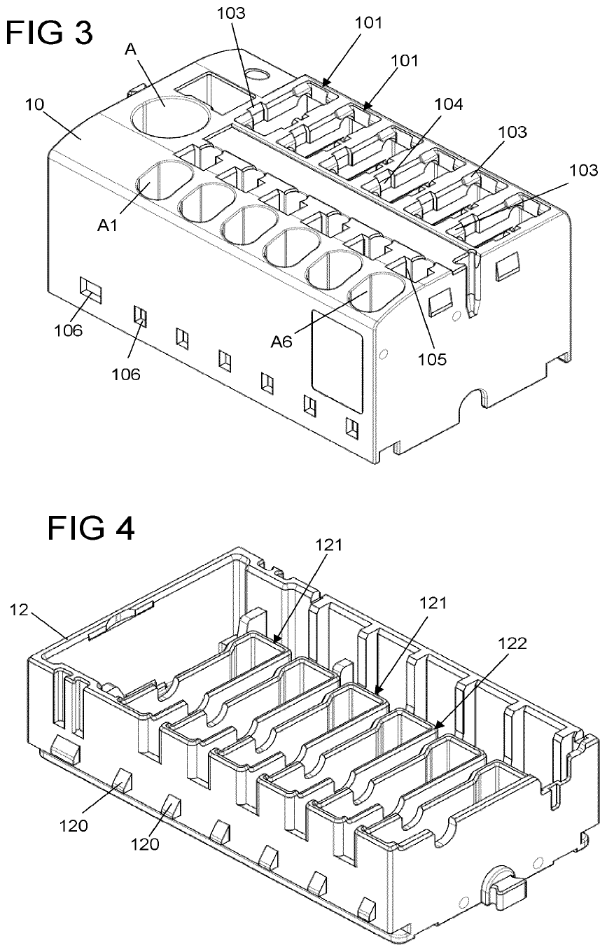

FIG. 3 shows the first housing part 10 separately. It can be seen that each shaft-shaped receiving section 101 in the example shown has a generally rectangular opening cross-section. However, additional lateral (optional) recesses 104 are provided on the sides of the opening of the respective receiving sections 101, for example for guiding the disconnection elements 13 or the other components 18A-18C. Furthermore, (optional) insertion slopes 103 are formed on the sides of the opening of the respective receiving sections 101 in order to latch the disconnection elements 13 or the other components 18A-18C in the housing G.

FIG. 4 shows the third housing part 12 already mentioned. The third housing part 12 is configured to be insertable into the first housing part 10. For each of the connections A1-A6 electrically connectable to the bus connection A, the third housing part 102 comprises a cage 121. The cage 121 for each of the connections A1-A6 has partition walls by means of which electrical lines electrically connected to the connections A1-A6 are electrically isolated from the adjacent connections and the electrical lines electrically connected to the bus connection A.

In the present case, a space, specifically a gap 122, is formed between the cage 121 of each of the connections A1-A6 and the cage 121 of the respective adjacent connection A1-A6 (or the cages 121 of the respective adjacent connections A1-A6).

FIG. 5 shows the second housing part 11 of the terminal 1. In the mounted state of the terminal 1, the second housing part 11 is enclosed between the first housing part 10 and the third housing part 12. In the present case, the second housing part 11 is arranged in an interior space defined by the first housing part 10 and the third housing part 12. The second housing part 11 is formed in one piece. The second housing part 11 can be produced and is produced in the present case by injection molding.

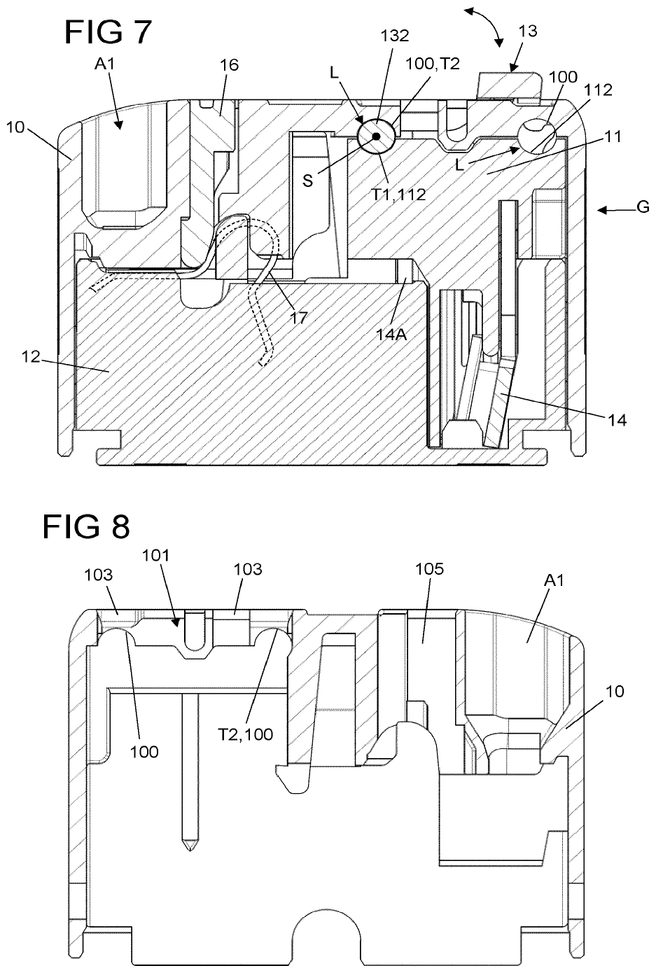

The second housing part 11 furthermore forms a receiving section 111 of the corresponding receptacle R for each of the disconnection elements 13 or other components 18A-18C. The receiving section 111 of the second housing part 11 adjoins the respective receiving section 101 of the first housing part 10. Each of the receiving sections 111 is defined by walls on which a plurality of recesses 112 are formed. In the present case, the recesses 112 are trough-shaped, more specifically: they describe a circular arc in cross-section. A plurality of such recesses 112 each form a section T1 of a mounting region L shown in FIG. 7 for the corresponding disconnection element 13 or other component 18A-18C.

Brackets 114 are formed in each of the receiving sections 111 for connection lines 14, 14A-14F explained in more detail in connection with FIG. 6.

The second housing part 11 furthermore comprises a plurality of partition walls 110. In each case, one of the partition walls 110 extends into one of the gaps 122 in the mounted state of the terminal 1, which enables particularly good isolation of adjacent connections A, A1-A6 and thus comparatively high voltages with simultaneously particularly small dimensions of the terminal 1.

Furthermore, for each of the connections A1-A6 (which are electrically connectable to the bus connection A via a respective disconnection element 13, or are generally electrically in operative connection with the bus connection A via a component arranged in the receptacle R), the second housing part 11 comprises a bearing 115 for a contact spring 17 shown in FIG. 7. The second housing part 11 can also be referred to as a spring holder.

FIG. 6 again shows, by way of example, the disconnection elements 13 in the contact position, in which the respective contact blade 130 makes electrical contact with both associated contacts K, K1-K6. Thereby, the contact K of the bus connection A is formed at a slot 140 (in a protruding section) of the bus connection line 14. The respective contact K1-K6 of the individual connections A1-A6 is formed at a slot 140 (in a protruding section) of the corresponding connection line 14A-14F.

The bus connection line 14 comprises a contact region 141 that can be electrically contacted by the electrical cable L1 inserted into the bus connection A.

The bus connection line 14 is shown separately in FIG. 12 and comprises a longitudinally extending strip, from which a plurality of, in the present case six, sections project laterally. On each of the sections, the slots 140 are formed, into which corresponding mating contacts of the components 13, 18A-18C can engage to make electrical contact. Inwardly protruding projections are provided on the slots 140, which projections enable an interference fit of the mating contacts and thus particularly reliable contacting. In the present case, the slots 140 of the individual connection lines 14A-14F are formed in the same way.

Each of the connection lines 14A-14F comprises a contact region 141, which can be electrically contacted by the electrical cable L1 inserted into the corresponding connection A1-A6. Each of the connection lines 14A-14F is U-shaped (see, in particular, FIG. 6), wherein the contact region 141 and the section with the slot 140 each form one of the two legs of the U.

The arrangement of (bus) connection lines 14, 14A-14F shown in FIG. 6 is arranged inside the terminal 1, specifically between the first, second and third housing parts 10, 11, 12. The arrangement in the third housing part 12 is shown in FIG. 11. It can be seen that the connection lines 14A-14F are arranged at least partially, in the present case for the most part, specifically: completely with the exception of the end sections, in the respective cages 121.

FIGS. 7 and 8 provide a view of the inside of terminal 1. It can, in particular, be seen that the housing G comprises the first housing part 10 and the second housing part 11, each of which forms a section T1, T2 of the mounting region L.

Both sections T1, T2 of the mounting region L each describe a circular arc of (slightly) less than a semicircle in cross-section. The two sections T1, T2 of the mounting region L are each formed by a recess 100, 112 in the first housing part 10 and in the second housing part 11. The recesses 100, 112 of the mounting region L together define a circular cylindrical cavity.

A pin 132 of the corresponding disconnection element 13 is received in the mounting region L. Alternatively, a corresponding pin of another component 18A-18C can be received therein.

Specifically, the inserted disconnection element 13 (or the other component 18A-18C) comprises, on both sides, a pin 132 (which are arranged coaxially), each of which is received in a corresponding mounting region L. On the mounting region L (specifically: at the mounting regions L), the disconnection element 13 is mounted so as to be pivotable about a pivot axis S. During a pivot movement about the pivot axis S, illustrated in FIG. 7 by means of a double arrow, the respective disconnection element 13 can be moved within the receptacle R (and at least partially pivoted out of the receptacle R). For this purpose, the receptacle R extends perpendicularly to the pivot axis S, at least in sections.

It can be seen in particular from FIGS. 5, 7 and 8 that the terminal 1 forms at least two mounting regions L on each receptacle R (in the present case, two mounting regions L on each side). The two mounting regions L are spaced apart from each other perpendicularly to a pivot axis S (or more generally: cylinder axis) defined by one of the mounting regions L. For example, if a component 18A-18C is latched into both mounting regions L, it will be mounted in a fixed and immovable manner relative to the housing G.

As already mentioned, the connections A, A1-A6 are designed in the form of push-in connections. For this purpose, a contact spring 17 is provided for each of the connections A, A1-A6. The contact spring 17 is mounted on the corresponding bearing 115 of the second housing part 11. The contact spring 17 comprises two spring legs. An electrical cable L1, L2 inserted into the corresponding connection A, A1-A6 displaces a spring leg of the contact spring 17, slides along an end edge thereof and then is pushed by the spring leg of the contact spring 17 to make electrical contact against the corresponding contact region 141.

In order to disconnect the electrical cable L1, L2 from the connection A, A1-A6 again, the slider 16 can be pushed deeper into the housing G so that the slider 16 releases the spring leg of the contact spring 17 from the electrical cable L1, L2 and the latter can be removed without causing destruction.

The combination of the push-in connections with the receptacles R permits a particularly compact design since the release by the slider 16 can be arranged in a particularly space-saving manner between the receptacle of the respective connection A1-A6 and the corresponding receptacle R and because the shape of the connection lines 14A-14F, which is adapted for this purpose, can be used synergistically for contacting the contact spring 17. The connections A1-A6 have, for example, a nominal cross-section of approximately 6 mm² for the plug-in (stripped) electrical cables L1.

In particular, it can be seen from FIG. 7 that the housing G has a lower side to which mounting material can optionally be fastened, in particular mounting material adapted depending on the place of use. For example, double-sided adhesive tape can be fixed to the flat lower side. Alternatively or additionally, corresponding rails can be connected with guides, visible in FIG. 7, on both sides, for example in combination with latching strips under the housing G (third housing part 12). Furthermore, it is possible to use the aforementioned positive-locking means to connect mounting blocks, for example to mounting blocks with at least one screw hole. In particular, since the housing G can be designed to be closed, a floating connection in non-fixed mounting is also possible.

Consequently, terminal 1 forms a bus block with connections for the bus connection line in the form of a bus bar and individual connections branching off therefrom (the connections A1-A6), along with a disconnection zone per individual connection. In particular, terminal 1 can serve as a potential bus block or potential distribution block.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SIGNS

1 Terminal
10 First housing part
100 Recess
101 Receiving section
102 Outer wall
103 Insertion slope
104 Recess
105 Shaft
106 Opening
11 Second housing part
110 Partition wall
111 Receiving section
112 Recess
114 Bracket
115 Bearing
12 Third housing part
120 Latching hook
121 Cage
122 Gap
13 Component (disconnection element)
130 Contact blade
131 Pivot body
132 Pin
133 Engagement region
14 (Bus) connection line
14A-14F Connection line
140 Slot
141 Contact region
15 Test contact
16 Slider
17 Contact spring
18A-18C Component
19 Test contact
A (Bus) connection
A1-A6 Connection
G Housing
K, K1-K6 Contact
L Mounting region
L1, L2 Electrical cable
R Absorption
S Pivot axis
T1, T2 Section
W Tool
X1-X6 Disconnection point

1. A terminal for electrical cables, comprising:
a housing on which are provided at least two connections for electrically connecting in each case one electrical cable to one connection line arranged in the housing,
wherein the connection lines are electrically disconnected from each other at a disconnection point between two contacts, and
wherein the housing forms at least one receptacle at which the contacts of the disconnection point of the connection lines are arranged such that they are electrically contactable by a component attachable to the at least one receptacle.

2. The terminal of claim 1, wherein at least one insertion slope is formed on the receptacle.

3. The terminal of claim 1, wherein at least one mounting region for a movable mounting of the component is formed on the receptacle.

4. The terminal of claim 3, wherein the mounting region has a substantially circular cross-section.

5. The terminal of claim 1, wherein the contacts are each formed on a slot.

6. The terminal of claim 1, wherein the receptacle comprises a shaft.

7. The terminal of claim 1, further comprising:
a plurality of receptacles arranged in a row.

8. The terminal of claim 7, wherein one of the connection lines comprises a bus connection line having a plurality of contacts, each contact of the plurality of contacts being arranged at one receptacle of the plurality of receptacles.

9. The terminal of claim 1, wherein at least one of the connections comprises a push-in connection.

10. A system, comprising:
at least one terminal of claim 1; and
at least two different components, each being selectively attachable to the at least one receptacle to electrically contact the contacts of the disconnection point of the connection lines.

11. The system of claim 10, wherein one component of the at least two different components comprises a disconnection element with a contact blade for contacting the contacts of the connection lines,
wherein the disconnection element is attachable to the receptacle such that the disconnection element is mounted so as to be movable between a contact position, in which the disconnection element electrically connects the contacts to each other, and a disconnection position, in which the disconnection element it-electrically disconnects the two contacts.

12. The system of claim 10, wherein one component of the at least two different components comprises a passive or active electrical component.
